(19) United States
(12) Patent Application Publication
(10) Pub. No.: US 2024/0289330 A1
(43) Pub. Date: Aug. 29, 2024

(54) GROUP-BY AND DISTINCT PUSHDOWN INTO UNION-ALL VIEWS

(71) Applicant: ORACLE INTERNATIONAL CORPORATION, Redwood Shores, CA (US)

(72) Inventors: RAFI AHMED, Fremont, CA (US); ANDREW WITKOWSKI, Foster City, CA (US)

(21) Appl. No.: 18/113,475

(22) Filed: Feb. 23, 2023

(51) Int. Cl. G06F 16/2453; G06F 11/34; G06F 16/242; G06F 16/2455

(52) U.S. Cl. CPC G06F 16/24535; G06F 11/3409; G06F 16/244; G06F 16/2456

(57) ABSTRACT

A mechanism is provided for performing a group-by pushdown operation or a distinct pushdown operation on a query. The query comprises an outer query block containing a view with a union-all operator, and the outer query block comprises an outer query statement referencing one or more columns of the union-all view and a group-by statement or a distinct keyword. Performing the group-by pushdown operation or the distinct pushdown operation on the query comprises modifying at least a given branch of the union-all view to include a distinct keyword in a query statement of the given branch or a group-by clause that groups results of the given branch by the one or more columns of the table of the given branch.

### FIELD OF THE INVENTION

The present invention relates to cost-based query transformation of queries having union-all and a group-by clause or distinct keyword. More specifically, the present invention relates to performing group-by or distinct pushdown into branches of a union-all view.

### BACKGROUND

Current relational database systems process complex structured query language (SQL) queries involving nested subqueries with aggregation functions, union/union-all, distinct, group-by views, etc. Query rewrite has been proposed as a heuristic transformation to optimize complex queries; however, there can be many possible variants of transformations, even for a simple SQL statement with respect to which transformations are to be applied and how. There is an added complexity when two or more transformations interact with each other.

In traditional relational database systems, query optimization generally consists of two phases of processing: logical and physical optimization phases. In the logical optimization phase, the given query is rewritten, generally based on heuristics or rules, into an equivalent but potentially more declarative and optimal form. The traditional physical optimizer works within the scope of a single query block, which ranges over a set of base tables with restriction, projection, and join. In the physical optimization phase, access methods, join orders, and join methods are chosen to generate an efficient plan for executing the query.

Existing heuristic and cost-based query transformations improve execution of queries to an extent; however, these transformations do not cover all conceivable cases, especially for complex queries, and further optimizations may be possible. More particularly, queries involving group-by and joins of union-all views are costly operations that could benefit from optimizations, as recognized and addressed by the illustrative embodiments described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 is a block diagram of a database server with a cost-based transformation framework in accordance with an illustrative embodiment.

FIG. 2 is a flowchart illustrating operation of a database server compiler performing group-by pushdown on a query in accordance with an illustrative embodiment.

FIG. 3 is a flowchart illustrating operation of a database server compiler performing distinct pushdown on a query in accordance with an illustrative embodiment.

FIG. 4 is a block diagram that illustrates a computer system upon which an embodiment of the invention may be implemented.

FIG. 5 is a block diagram of a basic software system that may be employed for controlling the operation of a computer system in accordance with an illustrative embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### GENERAL OVERVIEW

The illustrative embodiments propose two optimizations to improve the performance of workload queries: group-by pushdown and distinct pushdown into the branches of a union-all view. Group-by pushdown into union-all views (GPUA) is applied when the outer query block (OQB) contains a group-by clause; distinct pushdown into union-all views (DPUA) is applied when the OQB contains the DISTINCT keyword. A SELECT statement with the DISTINCT keyword is used to return only distinct (different) values and to remove duplicates from the results. A union-all view must have at least one valid branch to be considered valid for GPUA or DPUA. Not all branches are subject to GPUA or DPUA but are modified as explained further below. GPUA or DPUA is not done in a union-all branch if it already contains aggregation, group-by, or distinct, because no further reduction in the number of rows is possible. A query block with DISTINCT is semantically equivalent to the query block with group-by such that its GROUP BY and SELECT lists are the same. A small number of items in a group-by clause not only leads to a reduced set of resulting rows but its evaluation is also more efficient. The objective, therefore, is to introduce a minimal set of group-by keys in the branches.

In some embodiments, performing GPUA on a query comprises performing decomposition of aggregate functions. In one embodiment, performing decomposition of aggregate functions comprises modifying a branch of the union-all view to include a branch aggregate function, assigning an alias to the branch aggregate function, and modifying the aggregate function of the outer query block to reference the branch aggregate function. For set query blocks, there is a notion of union-compatibility, which requires that a pseudo-set query block and all its branches have the same number and type of SELECT list items. The SELECT list items of a pseudo-set query block refer by position to the SELECT list items of its branches. A pseudo-set view uses the SELECT list aliases of its first branch. Furthermore, an item is added to the SELECT list of branches of the union-all view that are not valid for GPUA to maintain union-compatibility.

The illustrative embodiments provide efficient techniques for the optimization of group-by and distinct query blocks containing union-all views, which may be inner or outer joined. GPUA and DPUA improve the performance of workload queries. Grouping or distinct in the branches of a union-all view may provide significant reduction in the number of rows, thereby providing reduction in the cost of group-by/distinct and joins in the outer query block. Group-by and distinct placement optimizations may take place in the union-all branches with pushed-down group-by and distinct respectively. This may make joins in the branches more efficient. For Exadata and integrated management controller (IMC) servers, if a branch has a single table, then the group-by or distinct operation can be off-loaded to the storage.

The GPUA and DPUA optimizations can be applicable to graph processing, decision support queries, and many application queries.

### Cost-Based Query Transformation

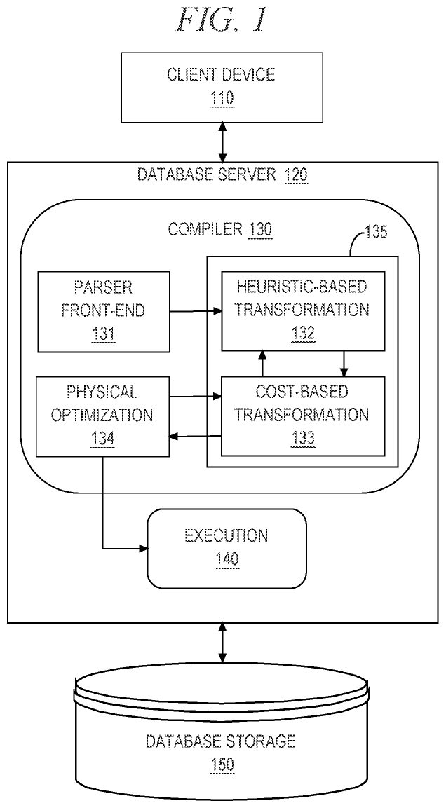

FIG. 1 is a block diagram of a database server with a cost-based transformation framework in accordance with an illustrative embodiment. The database server 120 receives queries from client device 110. The database server 120 performs compilation of queries using compiler 130, which includes parser front-end 131, heuristic-based transformation 132, cost-based transformation 133, and physical optimization 134. The parser front-end 131 deconstructs queries based on the query language syntax, such as structured query language (SQL) syntax, to identify each of the query components.

In the cost-based query transformation (CBQT) framework, logical transformation 135 and physical optimization 134 are combined to generate an optimal execution plan. Logical transformation 135 can be thought of as having two distinct components: heuristic-based transformation 132 and cost-based transformation 133. The CBQT framework comprises transformation algorithms that convert a complete or partial query tree into a semantically equivalent form, state spaces for various transformations, state-space search algorithms, capability for deep copying query blocks and their constituents, cost estimation techniques, and transformation directives and cost annotations. Physical optimization 134 generates a query execution plan, and execution 140 executes the query in accordance with the query execution plan against database 150. Cost-based query transformation frameworks are described in further detail in “Cost-Based Query Transformation in Oracle,” Proceedings of the 32^{nd} VLDB Conference, Seoul, S. Korea, 2006, the entire contents of which are incorporated by reference as if fully set forth herein. Further details of cost-based query transformations are described in U.S. Pat. No. 7,702,627, filed Mar. 8, 2007, and issued Apr. 20, 2010, the entire contents of which are incorporated by reference as if fully set forth herein.

In some embodiments, GPUA and DPUA are performed under a cost-based query transformation (CBQT) framework within the compiler 130 of database server 120. The cost-based query transformation (CBQT) framework generates various states for a given transformation and a given state-space search strategy, evaluates their optimizer estimated costs, and selects the state with the lowest estimated cost. GPUA and DPUA are independent transformations performed under the CBQT framework. For the exhaustive search of a union-all view V1 with M valid branches, the CBQT framework considers 2^{M} possible states choosing the cheapest state. A greedy search may consider one branch of a union-all view at a time selecting GPUA/DPUA for the branch if it reduces the cost. This greedy search evaluates (M+1) states. If in the same query block there is another union-all view V2 with N valid branches, then the CBQT framework considers (2^{M}×2^{N}) states for the exhaustive search and (M+N+1) states for the greedy search. A two-pass search considers two states: one state with group-by/distinct pushdown into all the valid branches of all the union-all views and the other state with no group-by/distinct pushdown.

Group-by placement (GBP) and distinct placement (DP) are performed independently under the CBQT framework. GBP/DP commutes joins and group-by/distinct in a group-by/distinct query block to determine whether performing early grouping/distinct on some of the tables can reduce the intermediate cardinality to make subsequent joins and group-by/distinct more optimal.

The CBQT framework performs all heuristic-based and cost-based transformations in a sequential order. GPUA immediately precedes group-by placement (GBP) in the sequential order. GPUA is interleaved with GBP. This means that if the cost of the outer query block is higher with GPUA, then GBP is performed in the union-all branches with pushed-down group-by. If GBP in the branches can make the cost of the outer query block cheaper, then GPUA is selected; otherwise, it is rejected. DPUA immediately precedes distinct placement (DP) in the sequential order. DPUA is interleaved with DP. This means that if the cost of the outer query block is higher with DPUA, then DP is performed in the union-all branches with pushed-down distinct. If DP in the branches can make the cost of the outer query block cheaper, then DPUA is selected; otherwise, it is rejected.

### Decomposition of Aggregate Functions

The SELECT list items (i.e., columns or expressions) of union-all branches with GPUA are of two types: aggregation items and non-aggregation items. The term “projection” refers to columns specified to be returned by a query block (in this case, a branch of a view), which are listed in the select list of a query block. That is, when the SELECT list items include one or more columns, those columns are projected by the query block (e.g., the branch of the view). Similarly, the outer query block may also project one or more columns. The aggregation items are referenced by the aggregate functions in the outer query block; the non-aggregation items, which may appear in the GROUP BY and WHERE clauses of the outer query block, are the rest. Predicates are used in the search condition of WHERE clauses and HAVING clauses, the join conditions of FROM clauses, and other constructs where a Boolean value is required. The non-aggregation items of a branch form the GROUP BY clause for the branch when group-by is pushed down. The number of items in either category can be zero.

In accordance with an illustrative embodiment, aggregate functions that are specified in the outer query block are decomposed when group-by pushdown takes place in a union-all view. GPUA can take place even if there are no aggregate functions in the outer query block.

There are three types of aggregate functions in the outer query block: (i) aggregate functions whose arguments come from union-all views that undergo GPUA; (ii) COUNT(*), which has no arguments; and, (iii) aggregate functions whose arguments come from non-GPUA views and tables.

The decompositions of the first and second types of aggregate functions are shown in Tables 1 and 2 below, and the decomposition of the third type of aggregate functions is shown in Table 3 below. These tables do not include the AVG aggregate function, because AVG(x) is converted to SUM(x)/COUNT(x). Example rewrites performed according to these tables are presented after describing the tables.

Table 1 shows coalesced decomposition for aggregate functions whose arguments come from union-all views and COUNT(*), which has no argument.

TABLE 1

| | | Branch | Branch with | Branch with | |
|---|---|---|---|---|---|
| OQB Original | OQB Modified | Original | Pushdown | No Pushdown | V |
| MIN(V.Y) | | T.C Y | MIN(T.C) Y | T.C Y | N, I, L, R |
| MAX(V.Y) | | T.C Y | MAX(T.C) Y | T.C Y | N, I, L, R |
| SUM(V.Y) | | T.C Y | SUM(T.C) Y | T.C Y | N, I, L, R |
| COUNT(V.Y) | SUM(V.C) | T.C Y | COUNT(T.C) Y | NVL2(T.C, 1, 0) Y | N, I, L |
| COUNT(V.Y) | NVL(SUM(V.Y), 0) | T.C Y | COUNT(T.C) Y | NVL2(T.C, 1, 0) Y | R |
| COUNT(*) | SUM(V.CS) | | COUNT(*) CS | 1 CS | N, I, L |
| COUNT(*) | SUM(NVL(V.CS, 1)) | | COUNT(*) CS | 1 CS | R |

In Table 1, V is a union-all view that is undergoing GPUA and T. C is a column or expression in the SELECT list of a branch of view V. The view column V. C references the branch item T. C. In case of COUNT(*), a new SELECT list item COUNT(*) is added to all branches with pushed-down group-by and 1 to a branch with no group-by pushdown; all newly added SELECT items are given the alias “CS.” Other SELECT list items where aggregate functions are introduced retain their aliases (e.g., Y in columns 3, 4, and 5 of Table 1), except when there are multiple references to SELECT list items in V. The last column in Table 1 refers to the type of join V participates in, as follows: N: V is not joined (i.e., there is no other table in the outer query block); I: Vis inner-joined; L: V is on the left of a left outer join (LOJ); R: Vis on the right of LOJ.

In rows 4 and 5 of Table 1, the “NVL2 (T. C, 1, 0)” function returns 1 if T. C is not null and returns 0 if T. C is null. In rows 5 and 7 of Table 1, the “NVL(SUM(V.Y), 0)” function returns SUM(V.Y) if SUM(V.Y) is not null and returns 0 if SUM(V.Y) is null.

Table 2 shows coalesced decomposition with multiple union-all views.

TABLE 2

| | | V1 Branch | V1 Branch with | V1 Branch with | |
|---|---|---|---|---|---|
| OQB Original | OQB Modified | Original | Pushdown | No Pushdown | V1 |
| MIN(V1.Y) | | T.C Y | MIN(T.C) Y | T.C Y | N, I, L, R |
| MAX(V1.Y) | | T.C Y | MAX(T.C) Y | T.C Y | N, I, L, R |
| SUM(V1.Y) | | T.C Y | SUM(T.C) Y | T.C Y | N, I, L, R |
| COUNT(V1.Y) | SUM(V1.Y*V2.CS) | T.C Y | COUNT(T.C) Y | NVL2(T.C, 1, 0) Y | N, I, L |
| COUNT(V1.Y) | NVL(SUM(V1.Y*v2.CS), 0) | T.C Y | COUNT(T.C) Y | NVL2(T.C, 1, 0) Y | R |
| COUNT(*) | SUM(V1.CS*V2.CS) | | COUNT(*) CS | 1 CS | N, I, L |
| COUNT(*) | SUM(NVL(V1.CS*V2.CS, 1)) | | COUNT(*) CS | 1 CS | R |

Table 2 shows two union-all views, V1 and V2, which appear in the same query block and are undergoing GPUA. Here, the arguments of the outer query block aggregate functions refer to the columns from V1. When the arguments of the outer query block aggregate functions refer to the columns from V2, V1 and V2 are interchanged in Table 2.

If V2 is on the right of LOJ, “V2.CS” will be replaced with “NVL(V2.CS, 1)” in Table 2. The “NVL(V2.CS, 1)” function returns V2.CS if V2.CS is not null and returns 1 if V2.CS is null. In the last two rows of Table 2, the branch modification applies to both V1 and V2.

Table 3 shows factored decomposition for aggregate functions whose arguments come from non-GPUA views and tables.

TABLE 3

| | | Branch with | Branch with | |
|---|---|---|---|---|
| OQB Original | OQB Modified | Pushdown | No Pushdown | V |
| MIN(T0.C) | | | | N, I, L, R |
| MAX(T0.C) | | | | N, I, L, R |
| SUM(T0.C) | SUM(T0.C*V.CS) | COUNT(*) CS | 1 CS | N, I, L |
| SUM(T0.C) | SUM(T0.C*NVL(V.CS, 1)) | COUNT(*) CS | 1 CS | R |
| COUNT(T0.C) | NVL2(T0.C, V.C, 0) | COUNT(*) CS | 1 CS | N, I, L |
| COUNT(T0.C) | SUM(CASE WHEN T0.C IS NULL | COUNT(*) CS | 1 CS | R |
| | THEN 0 | | | |
| | WHEN V.CS IS NULL | | | |
| | THEN 1 | | | |
| | ELSE V.CS END) | | | |

In Table 3, T0 is a base table or view, and V is a union-all view in the outer query block. V undergoes GPUA, but not T0. In Table 3, T0.C is a column or expression that appears as an argument of aggregate functions in the SELECT, ORDER BY, or HAVING clause of the outer query block. For SUM and COUNT, a new SELECT clause item COUNT(*) is added to all the union-all branches of V with group-by pushdown and 1 to all its branches with no group-by pushdown; all new SELECT list items are given the alias “CS.”

Table 4 shows factored decomposition with multiple union-all views. Table 4 is as follows:

TABLE 4

| | | V1 or V2 Branch | V1 or V2 Branch | |
|---|---|---|---|---|
| OQB Original | OQB Modified | with Pushdown | with No Pushdown | V1 or V2 |
| MIN(T0.C) | | | | N, I, L, R |
| MAX(T0.C) | | | | N, I, L, R |
| SUM(T0.C) | SUM(T0.C*V1.CS*V2.CS) | COUNT(*) CS | 1 CS | N, I, L |
| SUM(T0.C) | SUM(T0.C*NVL(V1.CS, 1) * | COUNT(*) CS | 1 CS | R |
| | NVL(V2.CS, 1)) | | | |
| COUNT(T0.C) | NVL2(T0.C, V1.CS*V2.CS, 0) | COUNT(*) CS | 1 CS | N, I, L |
| COUNT(T0.C) | SUM(CASE WHEN T0.C IS NULL | COUNT(*) CS | 1 CS | R |
| | THEN 0 | | | |
| | WHEN V1.CS IS NULL | | | |
| | OR V2.CS IS NULL | | | |
| | THEN 1 | | | |
| | ELSE V1.CS*V2.CS END) | | | |

Table 4 shows the decomposition when there are two union-all views, V1 and V2, which are undergoing GPUA. V1 or V2 can be on the right of LOJ in rows 4 and 6 of Table 4.

The decomposition of aggregate functions when there are more than two union-all views that undergo GPUA can be generalized from Tables 2 and 4 by replacing V2.CS by V2.CS*V3.CS* . . . *Vn.CS.

### Heuristic for GPUA and DPUA

In general, not all branches of a union-all view are candidates for GPUA or DPUA. The compiler applies the following heuristic: if a branch contains a single table, it has a unique column C on its SELECT list, and C is a non-aggregation column, then the branch is not considered valid for group-by or distinct pushdown. The idea behind the heuristic is that by adding a group-by clause or a DISTINCT keyword that contains a unique column will not provide any reduction in the resulting number of rows.

### Examples of GPUA

For GPUA with factored decomposition, consider query Q1 as follows:

Q1.

```
SELECT V.ten, V.hundred, SUM(T0.hundred) smm
FROM H_4K T0, (SELECT T1.ten, T1.hundred
  FROM G_4K T1
  WHERE T1.thousand < 500
  UNION ALL
  SELECT T2.ten, T2.hundred
  FROM T_5K T2
  WHERE T2.unique3 < 700) V
WHERE T0.ten = V.ten
GROUP BY V.ten, V.hundred;
```

The SELECT statements of the outer query block and the branches of the union-all are query statements. Thus, the outer query block has a query statement, and each branch of the union-all has a query statement. The FROM clauses identify a table from which one or more columns are queried. The WHERE clauses filter results of the query statement of the outer query block or a branch of the union-all. The GROUP BY clauses group results of the query statement by one or more columns. The UNION ALL operator combines result sets of query statements of two or more branches into a union-all view (e.g., V in query Q1). When GPUA is applied to Q1, it yields query Q2 as follows (modifications shown in bold):

Q2.

```
SELECT V.ten, V.hundred, SUM(T0.hundred * V.CS) smm
FROM H_4K T0, (SELECT T1.ten, T1.hundred, COUNT (*) CS
  FROM G_4K T1
  WHERE T1.thousand < 500
  GROUP BY T1.ten, T1.hundred
  UNION ALL
  SELECT T2.ten, T2.hundred, COUNT (*) CS
  FROM T_5K T2
  WHERE T2.unique3 <700
  GROUP BY T2.ten, T2.hundred) V
WHERE T0.ten = V.ten
GROUP BY V.ten, V.hundred;
```

In Q2, a GROUP BY clause is added to each branch of the union-all view V.COUNT(*), which is also added to the branches of V, is used as an argument of the SUM in the outer query block, in accordance with the decomposition shown in Table 3 above. The added COUNT(*) aggregation function in the branches is assigned the alias CS, which is referenced in the aggregation function in the outer query block as V.CS.

For union-all with multiple references, there may be multiple aggregate functions in the outer query block that have the same argument, i.e., they reference the same view column. A valid branch means that GPUA can take place in the branch, whereas a non-valid branch means that GPUA is illegal for the branch. In this case, new select list items containing aggregates must be added to valid branches; for non-valid branches, a copy of the item is added to the select list in order to maintain union-compatibility. Consider query Q3 as follows:

Q3.

```
SELECT V0.thd, V0.av, V1.hd, SUM(V1.ten) sm, MAX(V1.ten) mx
FROM (SELECT T1.thousand thd, AVG(T1.unique2) av
  FROM T1_100 T1
  WHERE T1.hundred < 51
  GROUP BY T1.thousand) V0
  (SELECT T3.hundred hd, T4.thousand th, T3.ten ten
  FROM T_10K T3, G_4K T4
  WHERE T3.unique3 = T4.unique 3
  UNION ALL
  SELECT T2.ten hd T2.hundred th, T2.unique1 ten
  FROM T_5K T2
  WHERE T2.unique3 < 250) V1
WHERE V0.thd = V1.th
GROUP BY V0.thd, V0.av, V1.hd;
```

GPUA on Q3 yields Q4, which has coalesced decomposition, which is as follows (modifications shown in bold):

Q4.

```
SELECT V0.thd, V0.av, V1.hd, SUM(V1.X) sm, MAX(V1.Y) mx
FROM (SELECT T1.thousand thd, AVG(T1.unique2) av
  FROM T1_100 T1
  WHERE T1.hundred < 51
  GROUP BY T1.thousand) V0
  (SELECT T3.hundred hd, T4.thousand th, SUM(T3.ten) X,
  MAX(T3.ten) Y
  FROM T_10K T3, G_4K T4
  WHERE T3.unique3 = T4.unique 3
  GROUP BY T3.hundred, T4.thousand
  UNION ALL
  SELECT T2.ten hd T2.hundred th, SUM(T2.unique1) X,
  MAX(T2.unique1) Y
  FROM T_5K T2
  WHERE T2.unique3 < 250
  GROUP BY T2.ten, T2.hundred) V1
WHERE V0.thousand = V1.th
GROUP BY V0.thd, V0.av, V1.hd;
```

In the first branch of V1, the select list item T3.ten is replaced with the aggregation function SUM(T3.ten) and is assigned a new alias. Similarly, in the second branch of V1, T2.unique1 is replaced with the aggregation function SUM(T2.unique1) and assigned a new alias. New items containing aggregate functions are added to the select list of the branches of V1 in Q4, in accordance with the decompositions shown in Table 1 above. In the outer query block, the SUM and MAX aggregate functions are modified to refer to the aggregate functions added to the branches of V1 by their aliases. Here, different aliases are used for new items that are added to the branches of V1.

For GPUA and group-by placement (GBP), consider query Q5, which has a union-all view and a base table TO. Q5 has an estimated cost of 169K. Query Q5 is as follows:

Q5.

```
SELECT V.ten, V.hundred, COUNT (*) cns
FROM H_4K T0, (SELECT T1.ten, T11.hundred
  FROM G_4K T1, T_10K T11
  WHERE T1.thousand > 50 and T1.hundred = T11.hundred
  UNION ALL
  SELECT T2.ten, T12.hundred
  FROM T_5K T2, T_10K T12
  WHERE T2.unique3 = T12.unique3 and T2.unique2 > 7) V
WHERE T0.ten = V.ten
GROUP BY V.ten, V.hundred;
```

Q5 undergoes GPUA to yield Q6, which has an estimated cost of 895. Q6 is as follows (modifications shown in bold):

Q6.

```
SELECT V.ten, V.hundred, SUM(V.CS) cns
FROM H_4K T0, (SELECT T1.ten, T11.hundred, COUNT (*) CS
  FROM G_4K T1, T_10K T11
  WHERE T1.thousand > 50 and T1.hundred = T11.hundred
  GROUP BY T1.ten, T11.hundred
  UNION ALL
  SELECT T2.ten, T12.hundred, COUNT (*) CS
  FROM T_5K T2, T_10K T12
  WHERE T2.unique3 = T12.unique3 and T2.unique2 > 7
  GROUP BY T2.ten, T12.hundred) V
WHERE T0.ten = V.ten
GROUP BY V.ten, V.hundred;
```

In Q6, a GROUP BY clause is added to each branch of the union-all view V.COUNT(*), which is also added to the branches of V, is used as an argument of the SUM in the outer query block, in accordance with the decomposition shown in Table 1 above. Q6 undergoes GBP to yield Q7, which has an estimated cost of 159. Query Q7 is as follows (modifications shown in bold):

Q7.

```
SELECT V.ten, V.hundred, SUM(V.CS) cns
FROM H_4K T0,
  (SELECT VW_{—}GBF_{—}8.ITEM3 ten, T11.hundred,
  SUM(VW_{—}GBF_{—}8.ITEM_{—}2) CS
  FROM (SELECT T1.hundred ITEM_1, COUNT (*) ITEM_2, T1.ten
  ITEM_3
    FROM G_4K T1
    WHERE T1.thousand > 50
    GROUP BY T1.hundred, T1.ten) VW_{—}GBF_{—}8, T_10K T11
  WHERE VW_{—}GBF_{—}8.ITEM_{—}1 = T11.hundred
  GROUP BY VW_{—}GBF_{—}8.ITEM_{—}1, T11.hundred
  UNION ALL
  SELECT T2.ten, T12.hundred, COUNT (*) CS
  FROM T_5K T2, T_10K T12
  WHERE T2.unique3 = T12.unique3 and T2.unique2 > 7
  GROUP BY T2.ten, T12.hundred) V
WHERE T0.ten = V.ten
GROUP BY V.ten, V.hundred;
```

In Q7, GBP takes place in the first branch of the union-all view V generating a new group-by view, VW_GBF_8. GBP allows pulling of the group-by operator up past the joins, which can be referred to as group-by view merging. A group-by query can undergo different types of group-by placement transformations depending upon its join graph and tables that are referenced in aggregate functions. Doing an early group-by evaluation may result in a significant reduction in the number of rows on which multiple group-by operators apply as well as the number of rows later used in the join; hence the overall performance of the query may improve.

For coalesced aggregation for multiple union-all views, there may be multiple union-all views in the outer query block that are valid for GPUA. Consider query Q8 where both union-all views, V1 and V2, are valid for GPUA. V2 is on the right of LOJ. Query Q8 is as follows:

Q8.

```
SELECT T1.x, V1.y, V2.z, SUM(V1.ml) sm, COUNT(V2.m2) cnt
FROM T1,
  (SELECT T3.y, T2.r, T3.ml
  FROM T2, T3
  WHERE T2.n = T3.n
  UNION ALL
  SELECT T4.y, T4.r, T5.ml
  FROM T4, T5
  WHERE T4.x = T5.x) V1
  (SELECT T6.z, T7.d, T7.m2
  FROM T6, T7
  WHERE T6.w = T7.w
  UNION ALL
  SELECT T8.z, T8.d, T8.m2
  FROM T8
  WHERE T8.u > 5) V2
WHERE T2.r = V1.r and T1.d = V2.d (+)
GROUP BY T1.x, V1.y, V2.z;
```

GPUA on Q8 yields Q9, where both union-all views, V1 and V2, undergo GPUA. Query Q9 is as follows (modifications shown in bold):

Q9.

```
SELECT T1.x, V1.y, V2.z, SUM(V1.m1*V2.CS) sm,
NVL(SUM(V2.m2*V1.CS) ,0) cnt
FROM T1,
  (SELECT T3.y, T2.r, SUM(T3.m1) m1, COUNT(*) CS
  FROM T2, T3
  WHERE T2.n = T3.n
  GROUP BY T3.y, T2.r
  UNION ALL
  SELECT T4.y, T4.r, SUM(T5.m1) m1, COUNT(*) CS
  FROM T4, T5
  WHERE T4.x = T5. x
  GROUP BY T4.y, T4.r) V1
  (SELECT T6.z, T7.d, COUNT(T7.m2) m2, COUNT(*) CS
  FROM T6, T7
  WHERE T6.w = T7.w
  GROUP BY T6.z, T7.d
  UNION ALL
  SELECT T8.z, T8.d, COUNT(T8.m2) m2, COUNT(*) CS
  FROM T8
  WHERE T8.u > 5
  GROUP BY T8.z, T8.d) V2
WHERE T2.r = V1.r and T1.d = V2.d (+)
GROUP BY T1.x, V1.y, V2.z;
```

Here, the aggregate functions are decomposed according to the rules given in Table 2. In this example, the numbers of SELECT list elements in the branches are minimized while still corresponding to all SELECT list elements in the outer query block that refer to the union-all views and satisfying the union-all compatibility requirements. Therefore, in the first branch of V1, the GROUP BY includes T3.y and T2.r, which are the SELECT list items other than aggregate functions; in the second branch of V1, the GROUP BY includes T4.y and T4.r, which are the SELECT list items of the branch other than aggregate functions; in the first branch of V2, the GROUP BY includes T6.z and T7.d, which are the SELECT list items of the branch other than aggregate functions; and in the second branch of V2, the GROUP BY includes T8.z and T8.d, which are the SELECT list items of the branch other than aggregate functions. Also, the SELECT lists of the branches of V1 include the aliases m1 and CS, which are referred to in the outer query block as V1.m1 and V1.CS, and the SELECT lists of the branches of V2 include the aliases m2 and CS, which are referred to in the outer query block as V2.m2 and V2.CS.

### Example DPUA

For DPUA, consider query Q10, which has the DISTINCT keyword in the outer query block. Query Q10 is as follows:

Q10.

```
SELECT DISTINCT V.ten, V.hundred, T1.thousand
  FROM H_4K T1, (SELECT T2.ten, T2.hundred
  FROM T_10K T2
  WHERE T2.thousand < 313
  UNION ALL
  SELECT T3.ten, T3.hundred
  FROM T_5K T3, T1_100 T4
  WHERE T3.thousand = T4.thousand and T3.unique3 > 400) V
WHERE T1.ten = V.ten;
```

When DPUA is applied to Q10, it yields Q11, which is as follows:

Q11.

```
SELECT DISTINCT V.ten, V.hundred, T1.thousand
FROM H_4K T1, (SELECT DISTINCT T2.ten, T2.hundred
  FROM T_10K T2
  WHERE T2.thousand < 313
  UNION ALL
  SELECT DISTINCT T3.ten, T3.hundred
  FROM T_5K T3, T1_100 T4
  WHERE T3.thousand = T4.thousand and T3.unique3 > 400) V
WHERE T1.ten = V.ten;
```

Here, the DISTINCT keyword is pushed down into the branches of the union-all view V.

### Procedural Over View

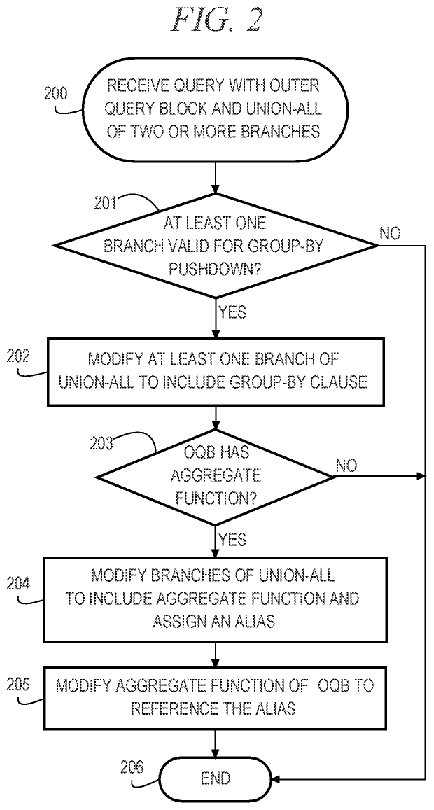

FIG. 2 is a flowchart illustrating operation of a database server compiler performing group-by pushdown on a query in accordance with an illustrative embodiment. Operation begins by receiving a query with an outer query block and a union-all of two or more branches (block 200). The compiler determines whether at least one branch of the union-all is valid for group-by pushdown (block 201). As stated above, a branch is not valid for GPUA if the branch contains a single table, it has a unique column on its SELECT list, and the unique column is a non-aggregation column. If no branches are valid (block 201: NO), then operation ends (block 206).

If at least one branch is valid for group-by pushdown (block 201: YES), then the compiler modifies at least one branch of the union-all to include a group-by clause (block 202). As described above, the group-by clause must satisfy union-compatibility requirements. The compiler determines whether the outer query block has an aggregate function (block 203). If the outer query block does not have an aggregate function (block 203: NO), then operation ends (block 206).

If the outer query block has an aggregate function, then the compiler modifies branches of the union-all to include an aggregate function according to a set of aggregate function decomposition rules, such as those shown in Tables 1-4 above, and assigns an alias (block 204). The compiler modifies the aggregate function of the outer query block to reference the alias according to the set of aggregate function decomposition rules (block 205). Thereafter, operation ends (block 206).

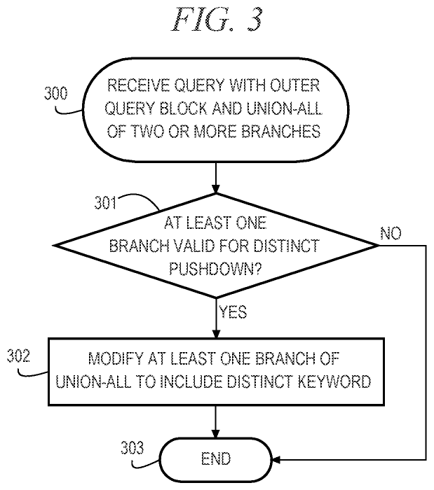

FIG. 3 is a flowchart illustrating operation of a database server compiler performing distinct pushdown on a query in accordance with an illustrative embodiment. Operation begins by receiving a query with an outer query block and a union-all of two or more branches (block 300). The compiler determines whether at least one branch of the union-all is valid for distinct pushdown (block 301). If no branches are valid (block 301: NO), then operation ends (block 303).

If at least one branch is valid for distinct pushdown (block 301: YES), then the compiler modifies at least one branch of the union-all to include a distinct keyword (block 302). Thereafter, operation ends (block 303).

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

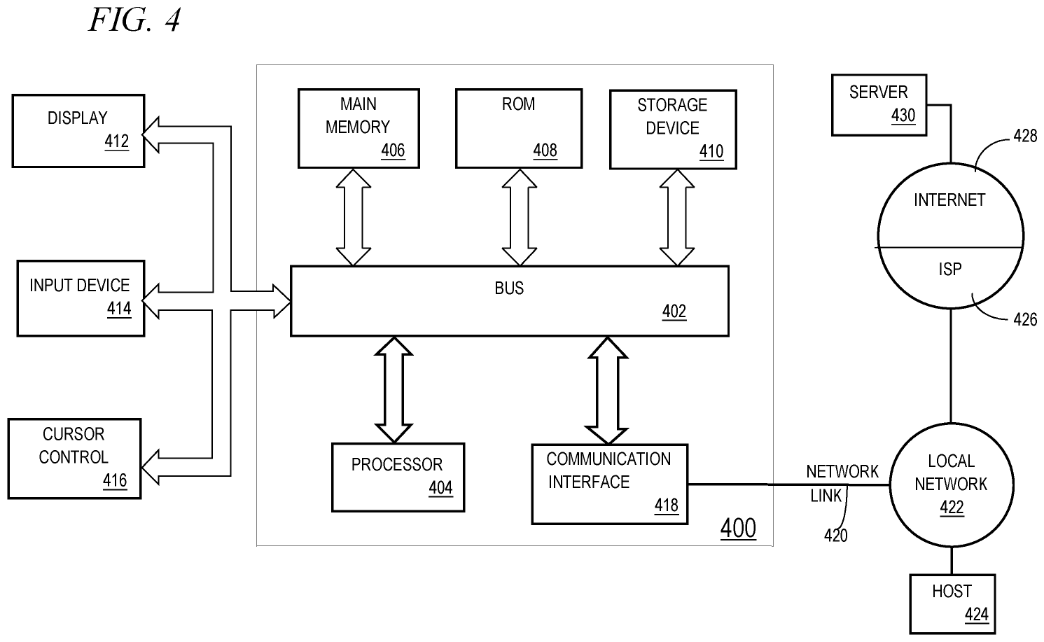

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world-wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

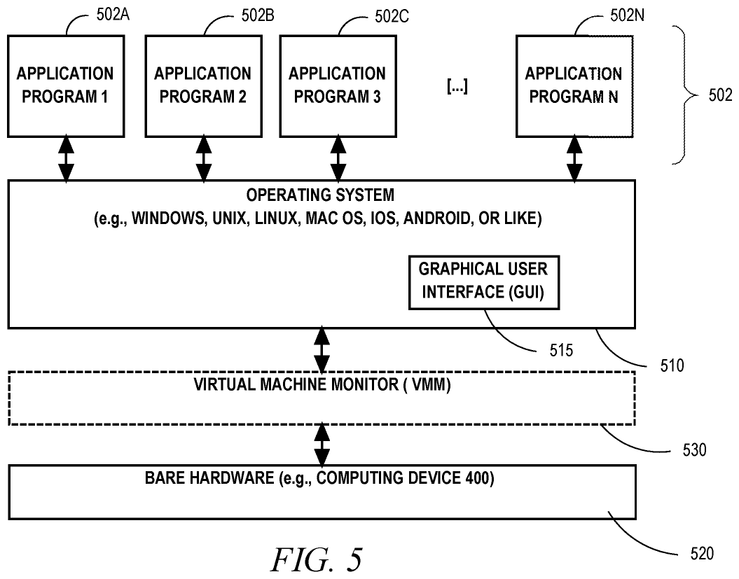

FIG. 5 is a block diagram of a basic software system 500 that may be employed for controlling the operation of computer system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computer system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### DBMS Over View

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
compiling a query, wherein:
the query comprises an outer query block containing a view with a union-all operator that forms a union-all view;
the union-all operator combines result sets of two or more branches;
the outer query block comprises an outer query statement referencing one or more columns of the union-all view and a group-by statement that groups results of the outer query statement;
each branch in the two or more branches projects one or more columns;
compiling the query comprises performing a group-by pushdown operation on the query to form a modified query in response to a determination that the query satisfies one or more criteria; and
performing the group-by pushdown operation on the query comprises modifying at least a given branch of the two or more branches to include a group-by clause that groups results of the given branch by the one or more columns of the given branch; and
executing the modified query.

2. The method of claim 1, wherein compiling the query further comprises:
responsive to determining that another branch of the two or more branches contains a single table, has a unique column, and the unique column is a non-aggregation column, determining that the another branch is not considered valid for the group-by pushdown operation.

3. The method of claim 2, wherein the one or more criteria comprise at least one branch of the two or more branches being a branch that is valid for the group-by pushdown operation.

4. The method of claim 1, wherein:
the outer query statement includes an aggregate function; and
performing the group-by pushdown operation on the query further comprises performing a decomposition operation on the aggregate function of the outer query statement; and
performing the decomposition operation comprises:
modifying the given branch to include a branch aggregate function;
assigning an alias to the branch aggregate function; and
modifying the aggregate function of the outer query statement, wherein modifying the aggregate function of the outer query statement comprises modifying the aggregate function of the outer query statement to reference the branch aggregate function by the alias.

5. The method of claim 4, wherein:
the aggregate function of the outer query statement is a count function;
modifying the aggregate function of the outer query statement comprises replacing the count function with a sum function; and
the branch aggregate function is a branch count function.

6. The method of claim 4, wherein modifying the aggregate function of the outer query statement comprises:
replacing the aggregate function of the outer query statement with a first aggregate function in response to a determination that the outer query block involves a first type of join operation; and
replacing the aggregate function of the outer query statement with a second aggregate function that is different from the first aggregate function in response to a determination that the outer query block involves a second type of join operation.

7. The method of claim 6, wherein the first type of join operation is a join operation where the union-all view is inner joined or on a left of a left outer join and the second type of join operation is a join operation where the union-all view is on a right of a left outer join.

8. The method of claim 6, wherein modifying the aggregate function of the outer query statement comprises replacing the aggregate function of the outer query statement with the first aggregate function in response to a determination that the outer query block does not involve a join with the union-all view.

9. The method of claim 4, wherein performing the decomposition operation further comprises:
modifying another branch of the two or more branches that is not considered valid for the group-by pushdown operation to include an item corresponding to the branch aggregate function; and
assigning the alias to the item.

10. The method of claim 9, wherein the item comprises one of:
a column specified by the another branch,
a function that returns one if the column specified by the another branch is not null and returns a value of zero if the column specified by the another branch is null, or
a value of one.

11. The method of claim 4, wherein:
the aggregate function of the outer query statement references an item of the given branch; and
modifying the given branch to include the branch aggregate function comprises replacing the item of the given branch with the branch aggregate function.

12. The method of claim 4, wherein:
the union-all view is a first union-all view;
the branch aggregate function is a first branch aggregate function;
the outer query block further comprises a second view with a second union-all operator that forms a second union-all view;
compiling the query further comprises performing a second group-by pushdown operation on at least one branch of the second union-all operator;
performing the second group-by pushdown operation comprises:
modifying a particular branch of the second union-all operator to include a second branch aggregate function; and
modifying the aggregate function of the outer query statement comprises modifying the aggregate function of the outer query statement to reference the first branch aggregate function of the first union-all view and the second branch aggregate function of the second union-all view by the alias.

13. The method of claim 4, wherein:
the aggregate function of the outer query statement is a sum function having an argument that comes from the union-all view; and
the branch aggregate function comprises a sum of a column of the one or more columns.

14. The method of claim 4, wherein:
the aggregate function of the outer query statement is a sum function having an argument that comes from a table or view for which a group-by pushdown has not been performed; and
the branch aggregate function comprises a count of a column of the one or more columns.

15. The method of claim 4, wherein:
the aggregate function of the outer query statement is an average function; and
performing the group-by pushdown operation on the query further comprises replacing the average function with a sum function divided by a count function prior to performing the decomposition operation.

16. The method of claim 1, wherein the outer query block further comprises a join or a filter predicate.

17. The method of claim 1, wherein the given branch further includes a join or a filter predicate.

18. The method of claim 1, wherein compiling the query further comprises performing a group-by placement operation on the group-by clause of the given branch.

19. The method of claim 1, wherein compiling said query includes selecting said modified query by performing a cost-based transformation, wherein said cost-based transformation compares a cost of said modified query to a cost of said query or a transformation of said query.

20. A computer-executed method comprising:
compiling a query, wherein:
the query comprises an outer query block and a view with a union-all operator that forms a union-all view;
the union-all operator combines result sets of two or more branches;
the outer query block comprises an outer query statement specifying one or more columns of the union-all view and a distinct keyword that removes duplicates of results of the outer query statement;
each branch in the two or more branches projects one or more columns;
compiling the query comprises performing a distinct pushdown operation on the query to form a modified query in response to a determination that the query satisfies one or more criteria;
performing the distinct pushdown operation on the query comprises modifying at least a given branch of the two or more branches to include a distinct keyword; and
executing the modified query.

21. One or more non-transitory storage media storing instructions which, when executed by one or more computing devices, cause performance of a method comprising:
compiling a query, wherein:
the query comprises an outer query block containing a view with a union-all operator that forms a union-all view;
the union-all operator combines result sets of two or more branches;
the outer query block comprises an outer query statement referencing one or more columns of the union-all view and a group-by statement that groups results of the outer query statement;
each branch in the two or more branches projects one or more columns;
compiling the query comprises performing a group-by pushdown operation on the query to form a modified query in response to a determination that the query satisfies one or more criteria; and
performing the group-by pushdown operation on the query comprises modifying at least a given branch of the two or more branches to include a group-by clause that groups results of the given branch by the one or more columns of the given branch; and
executing the modified query.

22. One or more non-transitory storage media storing instructions which, when executed by one or more computing devices, cause performance of a method comprising:
compiling a query, wherein:
the query comprises an outer query block and a view with a union-all operator that forms a union-all view;
the union-all operator combines result sets of two or more branches;
the outer query block comprises an outer query statement specifying one or more columns of the union-all view and a distinct keyword that removes duplicates of results of the outer query statement;
each branch in the two or more branches projects one or more columns;
compiling the query comprises performing a distinct pushdown operation on the query to form a modified query in response to a determination that the query satisfies one or more criteria;
performing the distinct pushdown operation on the query comprises modifying at least a given branch of the two or more branches to include a distinct keyword; and
executing the modified query.
